(19) United States
(12) Patent Application Publication
(10) Pub. No.: US 2011/0281666 A1
(43) Pub. Date: Nov. 17, 2011

(54) METHOD AND APPARATUS FOR GOLF CLUB PUTTER

(76) Inventor: Charles A. Hair, Eagle, CO (US)

(21) Appl. No.: 12/780,175

(22) Filed: May 14, 2010

(51) Int. Cl. A63B 53/04; B24B 1/00; B23P 11/00; B28D 1/00

(52) U.S. Cl. 473/340; 473/349; 125/2; 451/41; 29/428

(57) ABSTRACT

A golf putter head made of granite attached to a golf club shaft. The golf putter head may have a smooth polished front putter surface. The golf putter head may have center slot which is cut into the granite. The golf putter head may have a front, a rear, a right, and a left, wherein the golf putter head is tapered from the front to the rear, from the center to the left; and from the center to the right. The golf putter head may be made of single granite stone. The golf putter head may have a bore cut into the granite into which the shaft is inserted. The front putting surface may be formed by applying ultra fine sand paper in the range of 1000 to 1500 using the United States CAMI (Coated Abrasive Manufacturers Institute) grit designations. The method may further include cutting a slot into the golf putter head, wherein the slot is substantially perpendicular to the smooth front putting surface.

### FIELD OF THE INVENTION

This invention relates to improved methods and apparatus concerning golf club putters.

### BACKGROUND OF THE INVENTION

There are various devices known in the prior art for golf club putters.

### SUMMARY OF THE INVENTION

One or more embodiments of the present invention provide a putter head made of granite. The putter head may be formed from a raw granite block or piece using tools specific to granite fabrication. For example, a grinder or grinders, various styles of diamond blades and wheels, mechanical polishers, and buffers, may be used to form the putter head from the raw granite block or piece. Alternatively, the putter head may be formed in ways not common to granite fabrication.

It has been found by the present inventors that a putter head made of granite works well because of the weight and/or density of the granite putter head and the improved “feel” for putting a golfer has when putting with a putter that uses a granite putter head. The solidness of a natural granite stone in a polished fabricated state offers the user a feel unmatched by a metal putter head or a wood putter head. In accordance with one embodiment of the present invention, the granite putter head has a putter face surface (which is used to contact and putt a golf ball) which is typically not grooved but rather smoothed by using sand paper having an ultra-fine CAMI grit designation of between one thousand (1000) and fifteen hundred (1500) using the United States CAMI (Coated Abrasive Manufacturers Institute, now part of the Unified Abrasives Manufacturers' Association) system. The smooth putting surface causes a golf ball at impact with the putting surface to roll true and stay on the putting surface without “popping” up, which can occur when a putting surface has grooves on it.

In at least one embodiment of the present invention a golf putter head made of granite is attached to a shaft. The golf putter head may have a smooth polished front putter surface. The golf putter head may have center slot which is cut into the granite. The golf putter head may have a front, a rear, a right, and a left, wherein the golf putter head is tapered from the front to the rear, from the center to the left; and from the center to the right. The golf putter head may be made of single granite stone. The golf putter head may have a bore cut into the granite into which the shaft is inserted.

At least one embodiment of the present invention may include a method comprising forming a golf putter head from granite, and attaching a golf putter shaft to the golf putter head. The step of forming the golf putter head includes forming a smooth front putting surface. The step of forming a smooth front putting surface may include applying ultra fine sand paper to the piece of granite. The step of forming a smooth front putting surface may include applying ultra fine sand paper in the range of 1000 to 1500 using the United States CAMI (Coated Abrasive Manufacturers Institute) grit designations. The method may further include cutting a slot into the golf putter head, wherein the slot is substantially perpendicular to the smooth front putting surface.

### BRIEF DESCRIPTION OF THE DRAWINGS

FIG. 1 shows a top right front perspective view of a putter in accordance with an embodiment of the present invention;

FIG. 2 shows a top right front perspective view of a putter head for use with the putter of FIG. 1 in accordance with an embodiment of the present invention;

FIG. 3 shows a top view of the putter head of FIG. 2, along with dashed lines showing the location of a golf ball;

FIG. 4 shows a front view of the putter head of FIG. 2, along with dashed lines showing the location of a golf ball;

FIG. 5 shows a back view of the putter head of FIG. 2;

FIG. 6 shows a bottom view of the putter head of FIG. 2;

FIG. 7 shows a right side view of the putter head of FIG. 2;

FIG. 8 shows a left side view of the putter head of FIG. 2;

FIG. 9 shows a cross sectional cutout of another putter in accordance with another embodiment of the present invention; and

FIG. 10 shows a cross sectional view of the putter of FIG. 9 with a screw inserted holding a putter shaft to a putter head.

### DETAILED DESCRIPTION OF THE DRAWINGS

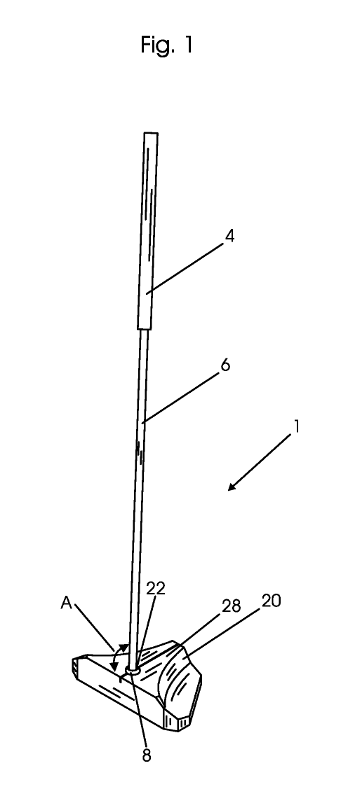

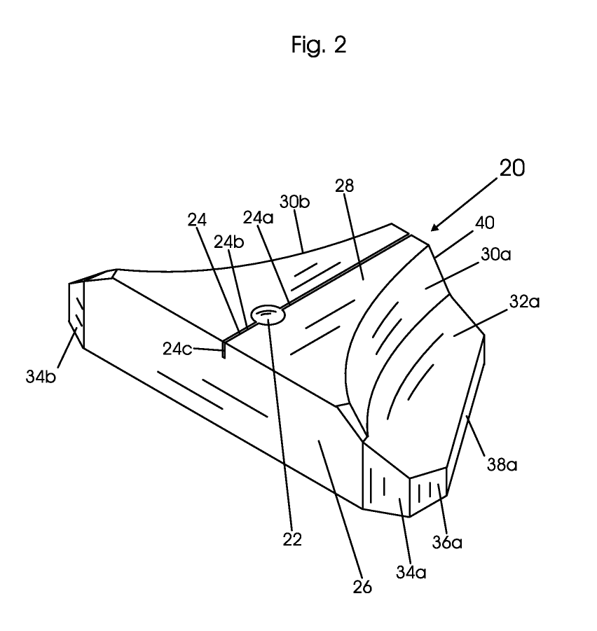

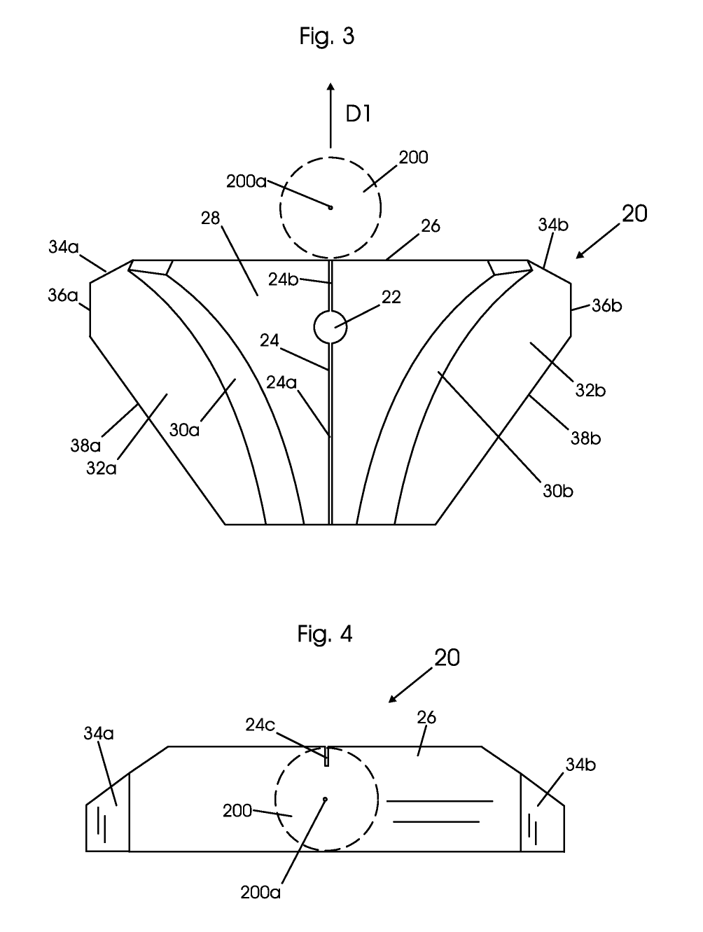

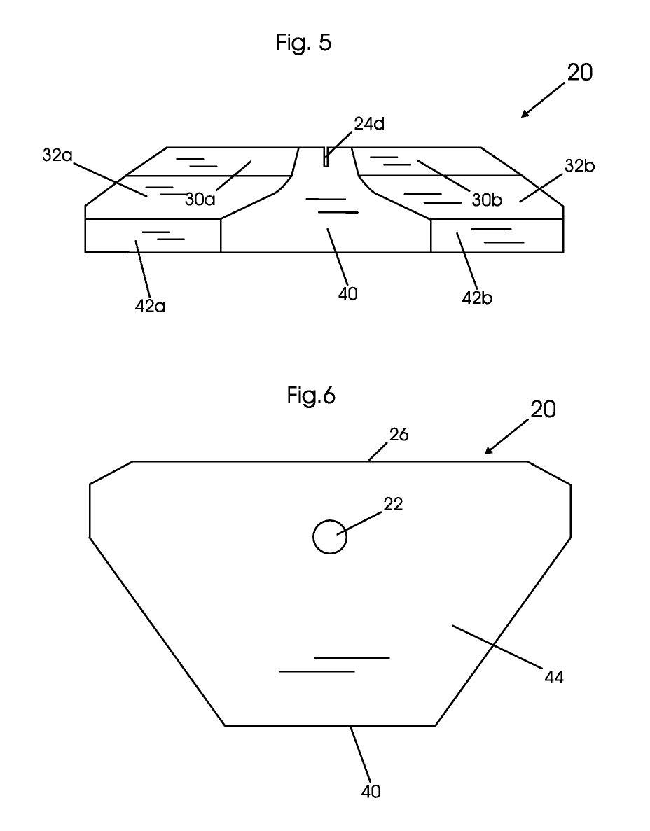

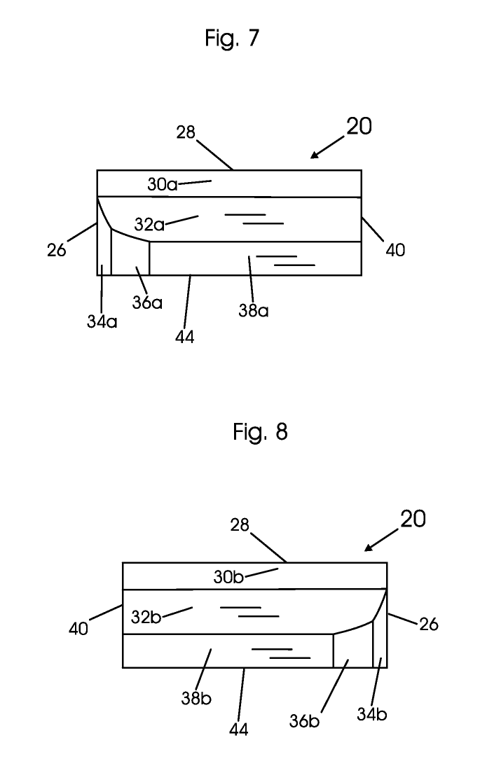

FIG. 1 shows a top right front perspective view of a putter 1 in accordance with an embodiment of the present invention. FIG. 2 shows a top right front perspective view of a putter head 20 for use with the putter 1 of FIG. 1 in accordance with an embodiment of the present invention. FIGS. 3-8 show top, front, back, bottom, right side, and left side views of the putter head 20 of FIG. 2.

Referring to FIG. 1, the putter 1 includes handle 4, shaft 6, and putter head 20. The shaft 6 may be inserted through an opening 22 in the putter head 20. The shaft 6 may be held to the putter head 20 by a screw, a bolt, by glue, epoxy, or in any other known manner. A washer 8 may be provided to aid in connecting the shaft 6 to the putter head 20. The shaft 6 may be connected and fixed to the putter head 20 so the shaft 20 makes an angle A with respect to the surface 28 of the putter head 20. The angle A may be ninety degrees or may be some other angle such as less than ninety degrees.

Referring to FIGS. 2-8, the putter head 20, in accordance with an embodiment of the present invention, may be made of granite. The putter head 20 may include a substantially flat, substantially smooth front surface 26 for striking a golf ball. The surface or putting front surface 26 may be formed from a block or piece of granite by using stationary and/or hand held tools related to granite and or solid surface counter top fabrication. The putter head 20 may include surfaces 34a-b and 36a-b which may be formed for artistic or esthetic reasons. The putter head 20 may also include top surface 28, curved surfaces 30a-b, 32a-b, surfaces 38a-b, rear surface 40, rear surfaces 42a-b, and bottom surface 44. The putter head 20 may have a substantially circular or circular hole 22 into which the shaft 6 may be inserted to connect and fix the shaft 6 to the putter head 20. The putter head 20 may have a slot 24 which may include portions 24a, 24b, 24c, and 24d. The slot 24, particularly the portions 24b and 24a, may be used to align a golf ball with the center of the surface 26. The slot portion 24c is preferably in the middle of the surface 26 for this reason. The slot portions 24a and 24b, together substantially bisect the top surface 28. The slot portion 24c is preferably at a right angle or substantially a right angle with respect to the slots portions 24b and 24a.

A golf ball, such as a golf ball 200 shown by dashed lines in FIGS. 3 and 4, can be struck with the surface 26 of the putter head 20. The golf ball 200 have its center 200a aligned with the slot portions 24b and 24c just prior to being struck as shown in FIGS. 3 and 4, respectively.

The slot 24 can be formed in the granite by a wooden jig and a dremmel tool with a circular diamond bit.

The general shape of the putter head 20, particularly for granite, is preferred. As shown in FIG. 2, putter head 20 is tapered from the front putter surface 26 to the rear surface 40. As shown by FIGS. 2 and 3, the putter head 20 is also tapered from the slot 24 to the left and right outer surfaces 38a and 38b. In this manner, the weight of the putter head 20 is concentrated towards the front putting surface 26 and towards the center slot 24. This particular shape for the putter head 20, particularly for granite, works well because the putter head 20 has its greatest mass on the center line or slot 24 and at the front surface 26 of the putter head 20 and this mass helps putts where a golf ball impacts the surface 26 substantially at the center line or slot 24, as shown by FIGS. 3 and 4, hold a truer line. With putts not hit on the aiming line or slot 24 (i.e. the golf ball, such as 200, contacts the surface 26 somewhere to the left or right of the slot 24, shown in FIG. 3), the center mass (near front surface 26 and slot 24) and weight tend to hold the putter head 20 “square”, with no twist or deflection allowing the ball 200 to still ‘roll out’ with little loss of speed. Referring to FIG. 3, holding the putter “square” means that if the putter head 20 is moving in the direction D1 just before it contacts the golf ball 200, then the putter head 20 stays “square” if the surface 26 stays perpendicular to the direction D1 through contact with the golf ball 200.

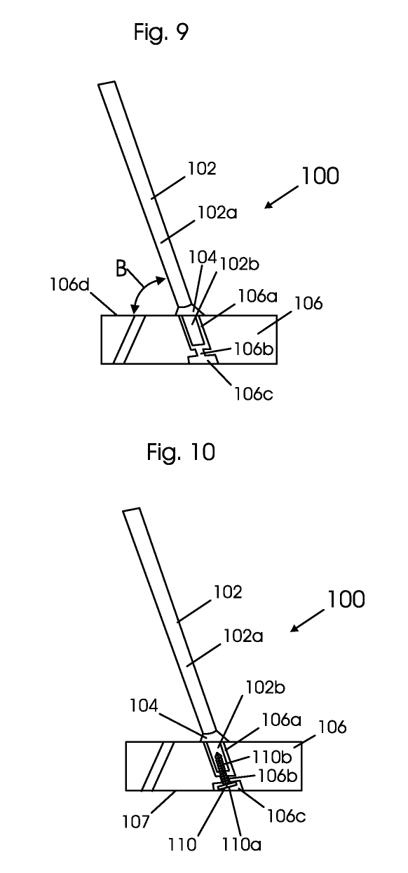

FIG. 9 shows a cross sectional cutout of a putter 100 in accordance with another embodiment of the present invention. The putter 100 may include a shaft 102 and a putter head 106. The shaft 102 may be inserted into an opening 106a in the putter head 106. The putter head 106, in accordance with an embodiment of the present invention is made of granite. The shaft 102 may have a portion 102b which is inserted into the opening 106a and which is fixed inside of the opening 106a and inside of the putter head 106. The shaft 102 may be fixed to the putter head 106, so that the shaft 102 is at an angle B with respect to the putter head 106, which may be ninety degrees or less than ninety degrees. The portion 102b may be a shaft peg or insert made of plastic or wood, forced and/or hammered to the opening 106a and epoxied or glued in the opening 106a of the putter head 106 in the position shown in FIG. 9. A portion 102a of the shaft 102 may lie outside of the putter head 106. The putter head 106 may also have openings 106b and 106c. The shaft 102 may be cylindrical or substantially cylindrical and the openings 106a, 106b, and 106c may be substantially cylindrical. The opening 106b may have a diameter which is less than the diameter of the shaft portion 102b so that the shaft portion 102b can not go through completely through the putter head 106. The shaft portion 102b may be a hollow cylinder with inner threads for screwing a screw 110 into. A washer 104 also aids in attaching the shaft 102 to the putter head 106.

FIG. 10 shows a cross sectional view of the putter 100 of FIG. 9 with a screw 110 inserted into the putter head 106. The screw 110 may have a cap portion 110a and a threaded body portion 110b. The threaded body portion 110b may have a diameter which is small enough to be inserted through the opening 106b and which screws into the inner threads of the shaft portion 102b in order to fix and hold the putter shaft 102 to the putter head 106. The cap portion 110a of the screw 110 has a diameter larger than the opening 106b so that the cap portion 110a cannot go through the opening 106b and thus cannot go completely through the putter head 106. The cap portion 110a fits into the opening 106 of the putter head 106, so that the cap portion 110a is not lower than the bottom surface 107. This presents a substantially smooth surface 107 unimpeded by the screw 110, i.e. the screw 110 does not protrude outward from the surface 107 which would make it more difficult to putt.

The portion or shaft peg 102b may have a diameter or width which is slightly larger than the shaft 102 and slightly larger than the inner diameter of the hole 106a of the putter head 106 for the purpose of fitting tighter in the hole 106a bored into the granite putter head 106. The wide girth or diameter of the shaft peg 102b forced into the bore or opening 106a gives the inventor the opportunity to adjust the lie angle, which may be an angle between the shaft, such as 102 and the putter head top surface, such as 106d, such as angle B shown in FIG. 9. Lie angles typically range between fifteen and thirty degrees. A loft angle, which may be the angle between the putter front surface, such as 106 and shaft 102, may range between zero and four degrees. The lie and loft angles of a putter, such as putters 1 and 100 may be set using plastic shims (such as plastic tooth picks) to hold the putter shafts 6 and 102, respectively, before adding in glue or epoxy into the openings 22 and 106a to hold the shafts 6 and 102 respectively in place with respect to the putter heads 20 and 106, respectively. In contrast, in the prior art for metal putters, loft and lie angles would be set at a milling stage.

The putter heads 20 or 106 made of granite, in accordance with an embodiment of the present invention, works well because of the weight and/or density of the granite putter head and the improved “feel” for putting a golfer has when putting with a putter that uses a granite putter head. The putter heads 20 or 106 may be formed from a natural granite stone. The putter head 20 or 106 may be formed by polishing a natural granite stone to form a putter front face or surface 26 or 106, respectively, which is typically not grooved but rather smoothed by using sand paper having a ultra-fine designation, such as CAMI grit designation of between one thousand (1000) and fifteen hundred (1500) using the United States CAMI (Coated Abrasive Manufacturers Institute, now part of the Unified Abrasives Manufacturers' Association) system. The smooth putting surface causes a golf ball at impact with the putting surface to roll true and stay on the putting surface without “popping” up, which can occur when a putting surface has grooves on it.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a golf putter head made of granite; and
a shaft attached to the golf putter head.

2. The apparatus of claim 1 wherein
the golf putter head has a smooth polished front putter surface.

3. The apparatus of claim 1 wherein
the golf putter head has a center slot which is cut into the granite.

4. The apparatus of claim 1 wherein
the golf putter head has a front, a rear, a right, and a left;
the golf putter head is tapered from the front to the rear;
the golf putter head is tapered from the center to the left; and
the golf putter head is tapered from the center to the right.

5. The apparatus of claim 1 wherein
the golf putter head is made of single granite stone.

6. The apparatus of claim 1 wherein
the golf putter head has a bore cut into the granite into which the shaft is inserted.

7. A method comprising the steps of:
forming a golf putter head from granite; and
attaching a golf putter shaft to the golf putter head.

8. The method of claim 7 wherein
the step of forming the golf putter head includes forming a smooth front putting surface.

9. The method of claim 8 wherein
the step of forming a smooth front putting surface includes applying ultra fine sand paper to the piece of granite.

10. The method of claim 9 wherein
the step of forming a smooth front putting surface includes applying ultra fine sand paper in the range of 1000 to 1500 using the United States CAMI (Coated Abrasive Manufacturers Institute) grit designations.

11. The method of claim 8 further comprising
cutting a slot into the golf putter head, wherein the slot is substantially perpendicular to the smooth front putting surface.

12. The method of claim 7
wherein the putter head is formed from a single granite stone.

13. The method of claim 7
the golf putter head has a front, a rear, a right, and a left;
the golf putter head is formed by tapering the granite from the front to the rear;
the golf putter head is formed by tapering the granite from the center to the left; and
the golf putter head is formed by tapering the granite from the center to the right.
